(19) United States
(12) Patent Application Publication
(10) Pub. No.: US 2008/0094342 A1
(43) Pub. Date: Apr. 24, 2008

(54) TIMING CONTROLLER, LIQUID CRYSTAL DISPLAY INCLUDING THE SAME, AND METHOD OF DISPLAYING AN IMAGE ON A LIQUID CRYSTAL DISPLAY

(75) Inventor: Kwan-ho Kim, Chungcheongnam-do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Gyeonggi-do (KR)

(21) Appl. No.: 11/829,253

(22) Filed: Jul. 27, 2007

(30) Foreign Application Priority Data
Oct. 24, 2006 (KR) 1020060103624

(51) Int. Cl. G09G 3/36

(52) U.S. Cl. 345/99

(57) ABSTRACT

A timing controller capable of reducing electromagnetic interference (EMI) and a liquid crystal display including the same are provided. The timing controller includes a line buffer memory, a comparing unit that compares first data information with second data information, and a memory allocating unit dividing the line buffer memory into a first memory unit and a second memory unit each having the same memory size according to results of the comparison. Also provided is a method of displaying an image on liquid crystal display that includes the timing controller.

This application claims priority to Korean Patent Application No. 10-2006-0103624, filed on Oct. 24, 2006, and all the benefits accruing therefrom under 35 U.S.C. 119, the contents of which in its entirety are herein incorporated by reference.

### BACKGROUND OF THE INVENTION

1. Field of the Invention

The present invention relates to a timing controller, a liquid crystal display including the same, and a method of displaying an image on a liquid crystal display. More particularly, the present invention relates to a timing controller capable of reducing electromagnetic interference (EMI) and a liquid crystal display including the same.

2. Description of the Related Art

Liquid crystal displays include a timing controller for supplying a plurality of pixel data and a data driver for supplying voltages corresponding to the pixel data supplied from the timing controller to a plurality of data lines in order to display an image.

In a single-channel driving mode, the timing controller sequentially supplies a plurality of input pixel data to the data driver. Usually, a high-resolution liquid crystal display requires many data lines, and as a result, is driven in a 2-channel driving mode. The timing controller classifies a data driver including a plurality of data driver integrated circuits (ICs) into a first data driver IC group and a second data driver IC group and stores a plurality of pixel data that are sequentially input. Then, the timing controller simultaneously outputs the pixel data to the first data driver IC group and the second data driver IC group. In order for this operation to perform, the timing controller stores a first image data set to be supplied to the first data driver IC group and a second image data set to be supplied to the second data driver IC group in a first memory unit and a second memory unit, respectively.

The timing controller allocates sufficient memory size to store the first image data set to the first and second memory units before receiving a plurality of pixel data. Therefore, a plurality of data drive ICs should be classified into the first data drive IC group and the second data drive IC group such that the data size of the first image data set is larger than the data size of the second image data set. That is, the number of data drive ICs included in the first data drive IC group is larger than the number of data drive ICs included in the second data drive IC group.

When the timing controller is mounted on a circuit board having a fixed shape, the timing controller is not mounted between the first data drive IC group and the second data drive IC group on the circuit board, but is mounted on the circuit board at a position closer to the first data drive IC group. Therefore, signal transmission lines for transmitting pixel data to the first data drive IC group include bent portions having an inside angle equal to or smaller than 90 degrees. In addition, the mounting position of the timing controller is limited. As a result, electromagnetic interference (hereinafter, referred to as “EMI”) occurs.

### BRIEF SUMMARY OF THE INVENTION

One aspect of the present invention provides a timing controller capable of reducing EMI.

Another aspect of the present invention provides a liquid crystal display capable of reducing EMI.

A further aspect of the present invention provides a method of displaying an image on a liquid crystal display.

The present invention however is not limited to the above exemplary embodiments, and other embodiments of the present invention will be apparently understood by those skilled in the art through the following description.

According to an exemplary embodiment of the present invention, a timing controller includes a line buffer memory, a comparing unit that compares first data information with second data information, and a memory allocating unit dividing the line buffer memory into a first memory unit and a second memory unit each having the same memory size to store the second data information according to results of the comparison.

According to another exemplary embodiment of the present invention, a liquid crystal display includes: a circuit board; a timing controller mounted on the circuit board and storing first to (n+m)-th pixel data that are sequentially input such that the pixel data are divided into a first image data set including the first to n-th pixel data and a second image data set including the (n+1)-th to (n+m)-th pixel data, and simultaneously outputting the pixel data from each of the stored first and second image data sets, the data size of the first image data set being smaller than the data size of the second image data set (m>n); a data driver electrically connected to the circuit board, supplying data voltages corresponding to the pixel data to a plurality of data lines, and including a first data drive IC group wherein the first data drive IC group includes first to s-th data drive ICs for applying the data voltages corresponding to the first to n-th pixel data and a second data drive IC group having (s+1)-th to (s+t)-th data drive ICs for applying the data voltages corresponding to the (n+1)-th to (n+m)-th pixel data, the number of data drive ICs of the first data drive IC group being smaller than the number of data drive ICs of the second data drive IC (t>s); and a liquid crystal panel displaying an image according to the data voltages applied through the plurality of data lines.

According to still another exemplary embodiment of the present invention, a liquid crystal display includes: a timing controller storing first to (n+m)-th pixel data that are sequentially input such that the pixel data are divided into a first image data set including the first to n-th pixel data and a second image data set including the (n+1)-th to (n+m)-th pixel data, and simultaneously outputting the pixel data from each of the stored first and second image data sets; a data driver including a first data drive IC group that is supplied with the first to n-th pixel data and applies data voltages corresponding to the first to n-th pixel data to some of a plurality of data lines and a second data drive IC group that is supplied with the (n+1)-th to (n+m)-th pixel data and applies data voltages corresponding to the (n+1)-th to (n+m)-th pixel data to the other data lines, the first data drive IC group including first to s-th data drive ICs and the second data drive IC including (s+1)-th to (s+t)-th data drive ICs; and a circuit board including the timing controller mounted thereon and first signal transmission lines that are connected between the timing controller and the first data drive IC group that transmit the first to n-th pixel data; and second signal transmission lines that are connected between the timing controller and the second data drive IC group that transmit the (n+1)-th to (n+m)-th pixel data. In the liquid crystal display, each of the first and second signal transmission lines comprises: first output lines provided on a first layer of the circuit board and sequentially transmitting the first to n-th pixel data and the (n+1)-th to (n+m)-th pixel data output from the timing controller at the same time; and second output lines provided on a second layer of the circuit board and transmitting the first to n-th pixel data and the (n+1)-th to (n+m)-th pixel data transmitted thorough the first output lines to the first to s-th data drive ICs and the (s+1)-th to (s+t)-th data drive ICs through paths, respectively. In addition, the first output lines may include a plurality of bent portions, and the inside angle of each of the bent portions is equal to or larger than 90 degrees.

According to still another exemplary embodiment of the present invention, a method for displaying an image on a liquid crystal display according to data voltages applied through a plurality of data lines is provided. The method includes mounting a timing controller on a circuit board, and storing first to (n+m)-th pixel data that is sequentially input such that the pixel data is divided into a first image data set including the first to n-th pixel data and a second image data set including the (n+1)-th to (n+m)-th pixel data. The method also includes simultaneously outputting the pixel data from each of the stored first and second image data sets, where the data size of the first image data set is smaller than the data size of the second image data set (m>n), electrically connecting a data driver to the circuit board, and supplying data voltages corresponding to the pixel data to the plurality of data lines. The method further includes applying the data voltages corresponding to the first to n-th pixel data via a first data drive IC group having first to s-th data drive ICs, and applying the data voltages corresponding to the (n+1)-th to (n+m)-th pixel data via a second data drive IC group having (s+1)-th to (s+t)-th data drive ICs. The number of data drive ICs of the first data drive IC group is smaller than the number of data drive ICs of the second data drive IC (t>s).

The method may also include storing the first image data set to a first memory unit within the timing controller, and storing the second image data set to a second memory unit within the timing controller.

The method may further include allocating a sufficient memory size to store the second image data set to a first memory unit and a second memory unit, where the first memory unit and second memory unit exist within the timing controller, storing the first image data set in the first memory unit, and storing the second image data set in the second memory unit.

The method may further include receiving first data information indicating the data size of the first image data set, receiving second data information indicating the data size of the second image data set, comparing the data size of the first image data set with the data size of the second image data set, and dividing a line buffer memory into a first memory unit and a second memory unit each having a sufficient memory size to store the second image data set according to the result of the comparison.

The method may further include mounting the timing controller between portions of the circuit board connected to the s-th data drive IC and the (s+1)-th data drive IC.

The method may further include connecting first signal transmission lines between the timing controller and the first data drive IC group, transmitting the first to n-th pixel data via the first signal transmission lines, connecting second signal transmission lines between the timing controller and the second data drive IC group, and transmitting the (n+1)-th to (n+m)-th pixel data via the second signal transmission lines.

Details of other exemplary embodiments are included in the detailed description of the invention and the accompanying drawings.

### BRIEF DESCRIPTION OF THE DRAWINGS

The above and other aspects, features, and advantages of the present invention will become more apparent by describing in detail exemplary embodiments thereof with reference to the attached drawings in which:

FIG. 1 is a block diagram illustrating an exemplary liquid crystal display according to an exemplary embodiment of the present invention;

FIG. 2 is an equivalent circuit diagram of one pixel shown in FIG. 1 in an exemplary embodiment;

FIG. 3 is a block diagram illustrating a timing controller shown in FIG. 1 in an exemplary embodiment;

FIG. 4 is a perspective view illustrating the arrangement structure of a data driver and the timing controller shown in FIG. 1 on a circuit board in an exemplary embodiment;

FIG. 5 is a perspective view illustrating an exemplary timing controller and a liquid crystal display including the timing controller according to an exemplary embodiment of the present invention;

FIG. 6 is an enlarged view of a portion “L” of FIG. 5;

FIG. 7 is a perspective view illustrating an exemplary timing controller and a liquid crystal display including the timing controller according to another exemplary embodiment of the present invention; and

FIG. 8 is a perspective view illustrating an exemplary timing controller and a liquid crystal display including the timing controller according to another exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected.

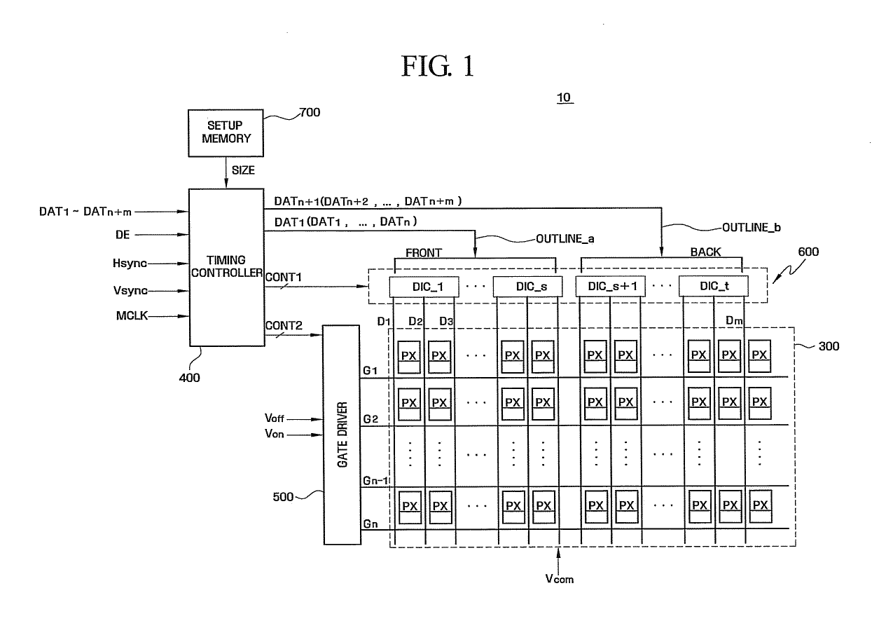

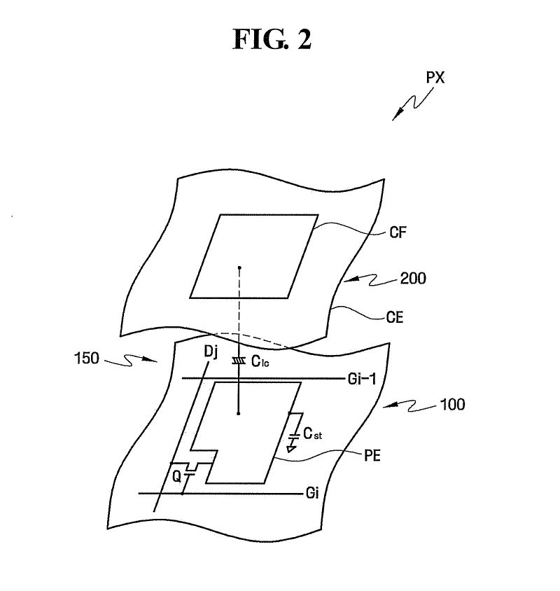

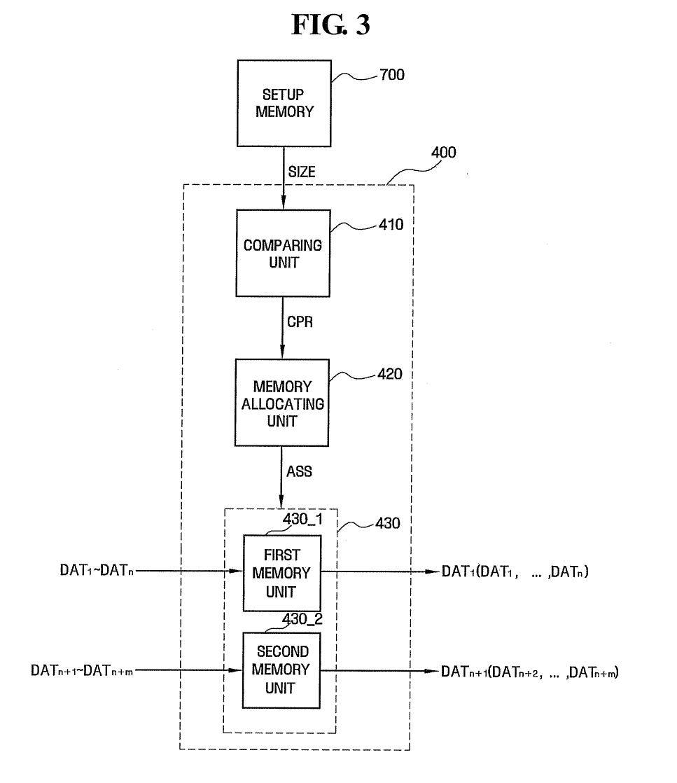

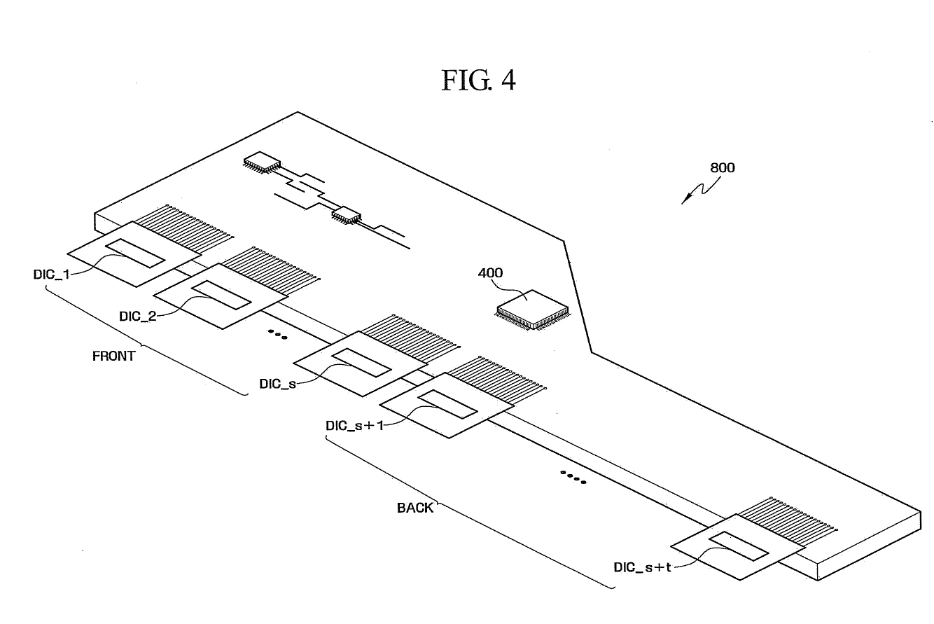

Hereinafter, an exemplary timing controller and a liquid crystal display according to exemplary embodiments of the present invention will be described with reference to FIGS. 1 to 4. FIG. 1 is a block diagram illustrating an exemplary liquid crystal display according to an exemplary embodiment of the present invention. FIG. 2 is an equivalent circuit diagram of one pixel shown in FIG. 1. FIG. 3 is a block diagram illustrating a timing controller shown in FIG. 1. FIG. 4 is a perspective view of a circuit board illustrating the arrangement structure of a data driver and the timing controller shown in FIG. 1.

Referring to FIG. 1, an exemplary liquid crystal display 10 according to an exemplary embodiment of the present invention includes a liquid crystal panel 300, a timing controller 400, a gate driver 500, a data driver 600, and a setup memory 700.

In the equivalent circuit diagram, the liquid crystal panel 300 includes a plurality of display signal lines G₁ to Gₙ and D₁ to Dₘ and a plurality of pixels PX that are connected to the display signal lines and are arranged in a matrix. The display signal lines G₁ to Gₙ and D₁ to Dₘ include a plurality of gate lines G₁ to Gₙ for transmitting gate signals and a plurality of data lines D₁ to Dₘ for transmitting data signals.

FIG. 2 is an equivalent circuit diagram of one pixel PX shown in FIG. 1 in accordance with one exemplary embodiment of the present invention. Color filters CF may be formed in some parts of a common electrode CE formed on a second display panel 200 so as to face pixel electrodes PE formed on a first display panel 100. Each pixel PX, for example, one pixel connected to an i-th (i=1, 2, . . . , p) gate line Gi and a j-th (j=1, 2, . . . , q) data line Dj includes a switching element Q connected to the signal lines Gᵢ and Dⱼ, and a liquid crystal capacitor Clc and a storage capacitor Cst connected to the switching element Q. The storage capacitor Cst may be omitted, if necessary.

A graphic controller (not shown) provided outside the timing controller 400 sequentially receives first to (n+m)-th pixel data DAT1 to DATₙ₊ₘ, and sequentially outputs a pair of pixel data. The graphic controller outputs the first pixel data DAT₁ and an (n+1)-th pixel data DATₙ₊₁ at the same time, and then outputs the second pixel data DAT₂ and an (n+2)-th pixel data DATₙ₊₂ at the same time. In this way, the graphic controller sequentially outputs a pair of pixel data, starting with the first pixel data DAT₁ and a (n+1)-th pixel data DATₙ₊₁. The first to (n+m)-th pixel data DAT₁ to DATₙ₊ₘ are pixel data applied to the pixel PX that is electrically connected to one of the gate lines G₁ to Gₙ.

More specifically, the timing controller 400 stores the first to (n+m)-th pixel data DAT₁ to DATₙ₊ₘ that are sequentially input such that the pixel data is divided into a first image data set including the first to n-th pixel data DAT₁ to DAT_{N} and a second image data including (n+1)-th to (n+m)-th pixel data DATₙ₊₁ to DATₙ₊ₘ. The data size of the first image data set may be smaller than that of the second image data set (m>n).

Next, the timing controller 400 simultaneously outputs one pixel data from each of the first image data set and the second image data set. In order for this operation to be performed, the timing controller 400 stores the first to (n+m)-th pixel data DAT₁ to DATₙ₊ₘ in a line buffer memory (not shown) provided in the timing controller 400.

The timing controller 400 stores the first image data set including the first to n-th pixel data DAT₁ to DATₙ in a first memory unit (not shown) of the line buffer memory (not shown) and the second image data set including (n+1)-th to (n+m)-th pixel data DATₙ₊₁ to DATₙ₊ₘ in a second memory unit (not shown) of the line buffer memory (not shown), respectively. The timing controller 400 receives first data information SIZE1 and second data information SIZE2 from the setup memory 700 and allocates the memory sizes of the first memory unit (not shown) and the second memory unit (not shown). The first data information SIZE1 and the second data information SIZE2 indicate the data size of the first image data set and the data size of the second image data, respectively. The detailed operation of the timing controller 400 will be described below with reference to FIG. 3.

The timing controller 400 receives an input control signal to generate a gate control signal CONT2 and a data control signal CONT1, and transmits the gate control signal CONT2 and the data control signal CONT1 to the gate driver 500 and the data driver 600, respectively.

Examples of the input control signal include a vertical synchronization signal Vsync, a horizontal synchronization signal Hsync, a main clock signal MCLK, and a data enable signal DE. The gate control signal CONT2 is a signal for controlling the operation of the gate driver 500, and includes a vertical start signal for starting the operation of the gate driver 500, a gate clock signal for determining the output timing of a gate-on voltage, an output enable signal for determining the pulse width of the gate-on voltage. The data control signal CONT1 is a signal for controlling the operation of the data driver, and includes a horizontal start signal for starting the operation of the data driver and a load signal for instructing the output of two data voltages.

The data driver 600 receives the pixel data DAT₁ to DATₙ₊ₘ from the timing controller 400 and supplies data voltages corresponding to the received pixel data to a plurality of data lines D₁ to Dₘ. The data driver 600 is divided into a first data drive IC group FRONT including first to s-th data driver ICs DIC_1 to DIC_s and a second data drive IC group BACK including (s+1)-th to (s+t)-th data driver ICs DIC_s+1 to DIC_s+t.

The first data drive IC group FRONT receives the pixel data DAT₁ to DATₙ of the first image data set from the timing controller 400 through a first signal transmission line OUTLINE_a. The second data drive IC group BACK receives the pixel data DATₙ₊₁ to DATₙ₊ₘ of the second image data set from the timing controller 400 through a second signal transmission line OUTLINE_b.

Since the data size of the first image data set stored in the timing controller 400 is smaller than the data size of the second image data set, the number of data drive ICs DIC_1 to DIC_s of the first data drive IC group FRONT may be smaller than the number of data drive ICs DIC_s+1 to DIC_t of the second data drive IC group BACK (t>s).

The gate driver 500 is connected to the gate lines G₁ to Gₙ, and supplies to the gate lines G₁ to Gₙ gate signals each of which is composed of a combination of a gate-on voltage Von and a gate-off voltage Voff generated by a gate-on/off voltage (Von and Voff) generator (not shown). The gate driver 500 supplies the gate-on voltage Von generated by the gate-on/off voltage generator (not shown) to the gate lines G₁ to Gₙ on the basis of the gate control signal CONT2 from the timing controller 400 to turn on the switching elements Q shown in FIG. 2 that are connected to the gate lines G₁ to Gₙ. Then, the data voltage applied to the data lines D₁ to Dₘ is applied to the corresponding pixels PX through the switching elements Q in the on state.

The following operation of the timing controller 400 will be described in detail with reference to FIG. 3: an operation of storing the first to (n+m)-th pixel data DAT₁ to DATₙ₊ₘ that are sequentially input such that the pixel data is divided into the first image data set including the first to n-th pixel data DAT₁ to DATₙ and the second image data including (n+1)-th to (n+m)-th pixel data DATₙ₊₁ to DATₙ₊ₘ and sequentially outputting the pixel data from each of the first image data set and the second image data set.

As shown in FIG. 3, the timing controller 400 includes a comparing unit 410, a memory allocating unit 420, and a line buffer memory 430.

The setup memory 700 has the first data information SIZE 1 indicating the data size of the first image data set and the second data information SIZE2 indicating the memory size of the second image data stored therein. Various data for the operation of the timing controller 400 other than the above may be stored in the setup memory 700. For example, conditions for generating the data control signal CONT1 and the gate control signal CONT2 may be stored in the setup memory 700. The setup memory 700 may be an EEPROM (electrically erasable and programmable read only memory).

The comparing unit 410 receives the first data information SIZE 1 indicating the data size of the first image data set and the second data information SIZE2 indicating the memory size of the second image data to compare the data sizes. For example, the first data information SIZE1 may be the number of data lines electrically connected to the first data drive IC group FRONT, and the second data information SIZE2 may be the number of data lines electrically connected to the second data drive IC group BACK. For instance, the comparing unit 410 notifies the memory allocating unit 420 of one of the first and second image data sets having a large memory size according to the result of the comparison.

The memory allocating unit 420 divides the line buffer memory 430 into a first memory unit 430_1 and a second memory unit 430_2 which have the same memory size according to the comparison result CPR. For example, the first memory unit 430_1 and the second memory unit 430_2 may have a memory size capable of storing the second image data set. The line buffer memory 430 stores the first to (n+m)-th pixel data DAT₁ to DATₙ₊ₘ supplied to the pixels that are electrically connected to any one of the gate lines G₁ to Gₙ.

When the memory sizes of the first memory unit 430_1 and the second memory unit 430_2 are allocated, the memory allocating unit 420 sequentially receives the first to (n+m)-th pixel data DAT₁ to DATₙ₊ₘ from a graphic controller (not shown). First, the memory allocating unit 420 stores in the first memory unit 430_1 the first to n-th pixel data DAT₁ to DATₙ that are sequentially input. Then, the memory allocating unit 420 stores in the second memory unit 430_2 the (n+1)-th to (n+m)-th pixel data DATₙ₊₁ to DATₙ₊ₘ that is sequentially input. Subsequently, the memory allocating unit 420 sequentially outputs pixel data from each of the first image data set and the second image data stored in the first memory unit 430_1 and the second memory unit 430_2, respectively. The pixel data DAT₁ to DATₙ output from the first memory unit 430_1 are input to the first data drive IC group FRONT, and the pixel data DATₙ₊₁ to DATₙ₊ₘ output from the second memory unit 430_2 are input to the second data drive IC group BACK.

Alternatively, the first to n-th pixel data DAT₁ to DATₙ are may be stored in the first memory unit 430_1, and some of the (n+1)-th to (n+m)-th pixel data DATₙ₊₁ to DATₙ₊ₘ may be stored in the second memory unit 430_2. Then, the other of the (n+1)-th to (n+m)-th pixel data DATₙ₊₁ to DATₙ₊ₘ may be stored in the second memory unit 430_2 and simultaneously, output pixel data from each of the first memory unit 430_1 and the second memory unit 430_2.

The timing controller 400 compares the data size of the first image data set with the data size of the second image data set, and allocates the same memory size to the first memory unit 430_1 and the second memory unit 430_2 so as to store the second image data set having a larger size. Then, the timing controller 400 stores the first image data set and the second image data set in the first memory unit 430_1 and the second memory unit 430_2, respectively, and supplies a pair of pixel data to the first data drive IC group FRONT and the second data drive IC group BACK, respectively. Therefore, the number of data drive ICs included in the first data drive IC group FRONT can be smaller than the number of data drive ICs included in the second data drive IC group BACK.

Thus, the timing controller 400 may be mounted between the first data drive IC group FRONT and the second data drive IC group BACK on the circuit board.

The arrangement structure of the timing controller 400 and the data drive ICs on the circuit board will be described in detail below with reference to FIG. 4.

Referring to FIG. 4, the timing controller 400 for outputting the first to (n+m)-th pixel data DAT₁ to DATₙ₊ₘ and a plurality of circuits are mounted on a circuit board 800 so as to be electrically connected to a plurality of drive ICs DIC_1 to DICₛ₊ₜ. Although not shown in FIG. 4, the plurality of drive ICs DIC_1 to DICₛ₊ₜ are electrically connected to a liquid crystal panel 300 (see FIG. 1) and apply data voltages corresponding to the pixel data to a plurality of data lines (see symbols D₁ to Dₘ of FIG. 1).

The timing controller 400 may be arranged between the first data drive IC group FRONT and the second data drive IC group BACK. More specifically, the timing controller 400 may be interposed between portions of the circuit board 800 that are connected to an s-th data drive IC DIC_s and an (s+1)-th data drive IC DIC_s+1. In this case, the number of data drive ICs DIC_1 to DIC_s included in the first data drive IC group FRONT may be smaller than the number of data drive ICs DIC_s+1 to DIC_s+t included in the second data drive IC group BACK (t>s).

EMI is reduced when the timing controller 400 is provided between the first data drive IC group FRONT and the second data drive IC group BACK, as will be described in detail below.

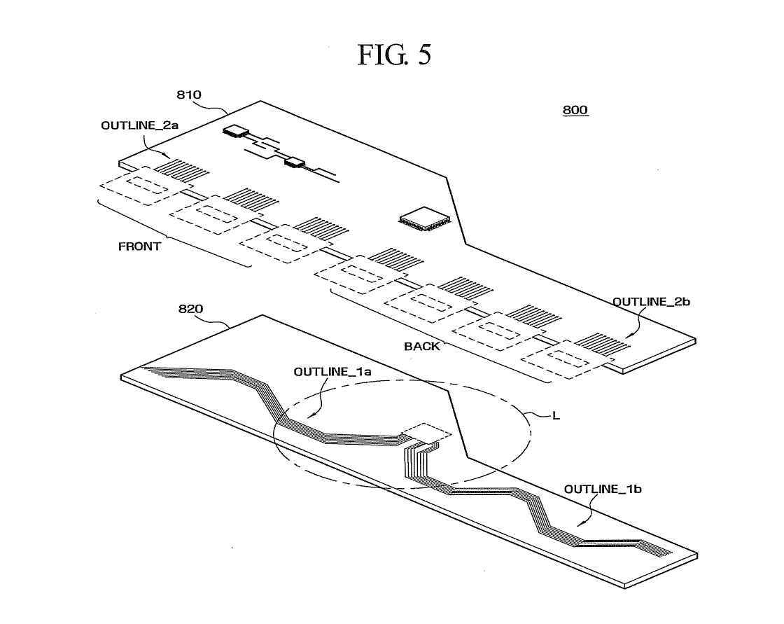

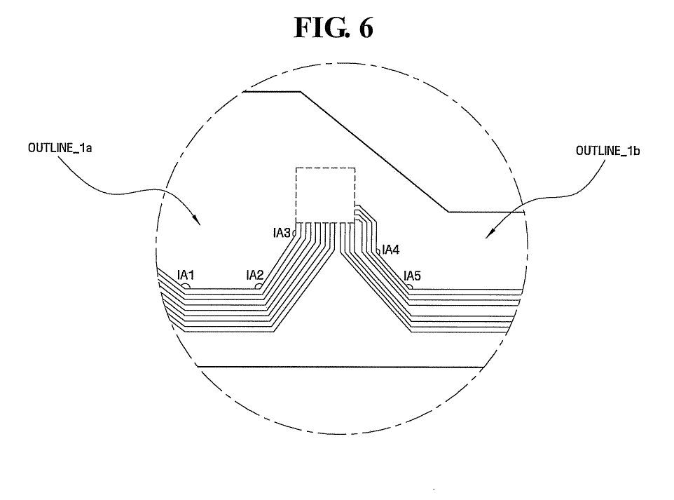

FIG. 5 is a perspective view illustrating a timing controller and a liquid crystal display including the same according to an embodiment of the invention, and FIG. 6 is an enlarged view of a portion L of FIG. 5. In this embodiment, seven data drive ICs are provided, and a circuit board 801 includes a first layer 820 and a second layer 810.

Referring to FIGS. 5 and 6, a timing controller 401 is arranged between the first data drive IC group FRONT and the second data drive IC group BACK.

The circuit board 801 includes first signal transmission lines OUTLINE_a that are connected between the timing controller 401 and the first data drive IC group FRONT and transmit the first to n-th pixel data therebetween and second signal transmission lines OUTLINE_b that are connected between the timing controller 401 and the second data drive IC group BACK and transmit the (n+1)-th to (n+m)-th pixel data therebetween.

The first signal transmission lines OUTLINE_a include first output lines OUTLINE_1a that are provided on the first layer 820 of the circuit board 801 and transmit the first to n-th pixel data sequentially output from the timing controller 401 and second output lines OUTLINE_2a that are provided on the second layer 810 of the circuit board 801 and transmit the first to n-th pixel data from the first output lines OUTLINE_1a to the first data drive IC group FRONT through paths (not shown).

The second signal transmission lines OUTLINE_b include first output lines OUTLINE_1b that are provided on the first layer 820 of the circuit board 801 and transmit the (n+1)-th to (n+m)-th pixel data sequentially output from the timing controller 401 and second output lines OUTLINE_2b that are provided on the second layer 810 of the circuit board 801 and transmit the (n+1)-th to (n+m)-th pixel data from the first output lines OUTLINE_1b to the second data drive IC group BACK through paths (not shown).

Therefore, the pixel data of the first image data set output from the timing controller 401 are transmitted through the first output lines OUTLINE_{—1}a and OUTLINE_1b of the first layer 820 of the circuit board 801 and then supplied to one data drive IC of the first data drive IC group FRONT through paths (not shown) and the second output lines OUTLINE_2a and OUTLINE_2b of the second layer 810 of the circuit board 801. In addition, the pixel data of the second image data set output from the timing controller 401 are transmitted through the first output lines OUTLINE_{—1}a and OUTLINE_1b of the first layer 820 of the circuit board 801 and then supplied to one data drive IC of the second data drive IC group BACK through paths (not shown) and the second output lines OUTLINE_2a and OUTLINE_2b of the second layer 810 of the circuit board 801.

Since the timing controller 401 is disposed between the first data drive IC group FRONT and the second data drive IC group (BACK) on the circuit board 801, it is possible to design the arrangement structure of the first output lines OUTLINE_{—1}a and OUTLINE_1b such that EMI can be reduced to a minimum. For example, some portions of the first output lines OUTLINE_{—1}a and OUTLINE_1b may be bent such that the inside angles IA1, IA2, IA3, IA4, and IA5 of the bent portions are equal to or larger than 90 degrees, as shown in FIG. 6.

If the number of data drive ICs of the first data drive IC group FRONT is larger than the number of data drive ICs of the second data drive IC group BACK, the timing controller 401 cannot be disposed between the first data drive IC group FRONT and the second data drive IC group BACK on the circuit board having a fixed shape. In this case, the first output lines OUTLINE_{—1}a and OUTLINE_1b have bent portions having the inside angles IA1, IA2, IA3, IA4, and IA5 equal to or smaller than 90 degrees, which causes an increase in EMI.

However, in this embodiment of the invention, since the number of data drive ICs included in the first data drive IC group FRONT is smaller than the number of data drive ICs included in the second data drive IC group BACK, the timing controller 401 can be disposed between the first data drive IC group FRONT and the second data drive IC group BACK on the circuit board 801, and the first output lines OUTLINE_{—1}a and OUTLINE_1b extend without bent portions having the inside angles IA1, IA2, IA3, IA4, and IA5 equal to or smaller than 90 degrees, which results in a reduction in EMI.

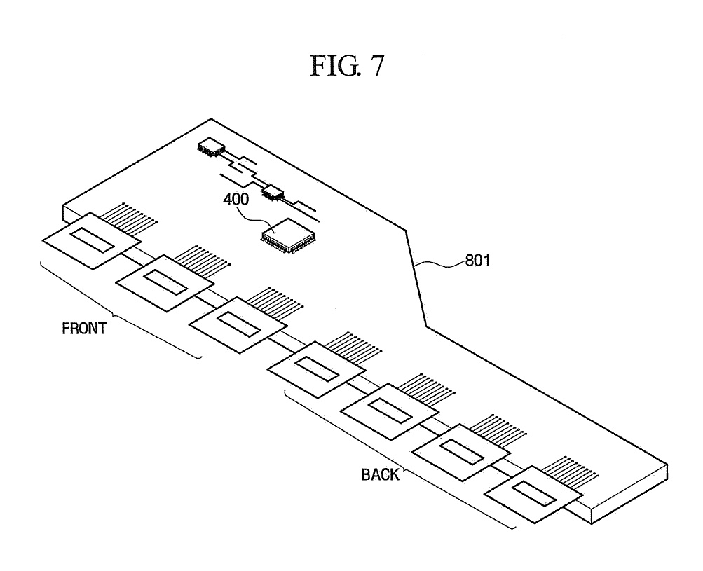

FIG. 7 is a perspective view illustrating another exemplary embodiment of a timing controller and a liquid crystal display including the same.

Unlike the above-described embodiment, in the embodiment shown in FIG. 7, the first data drive IC group FRONT includes two data drive ICs, and the second data drive IC group BACK includes five data drive ICs.

In this embodiment, similar to the above-described embodiment, a timing controller 402 is mounted between the first data drive IC group FRONT and the second data drive IC group BACK on a circuit board 802, and thus the first output lines OUTLINE_{—1}a and OUTLINE_1b extend without bent portions having inside angles equal to or smaller than 90 degrees. In addition, space is ensured around the timing controller 402, which makes it possible to form a ground area supplied with a ground voltage for the circuit board 802 around the timing controller 402. Therefore, it is possible to reduce EMI generated from the timing controller 402 and the circuit board 802 having the timing controller 402 mounted thereon.

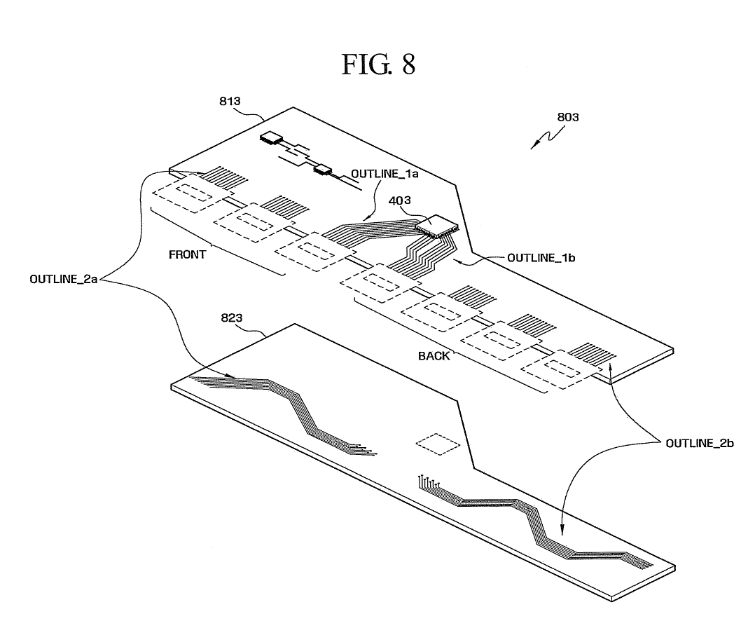

FIG. 8 is a perspective view illustrating another exemplary embodiment of a timing controller and a liquid crystal display including the same.

Referring to FIG. 8, a timing controller 403 is arranged between the first data drive IC group FRONT and the second data drive IC group BACK.

The circuit board 801 includes first signal transmission lines a connected between the timing controller 403 and the first data drive IC group FRONT and transmitting the first to n-th pixel data, and second signal transmission lines connected between the timing controller 403 and the second data drive IC group BACK and transmitting the (n+1)-th to (n+m)-th pixel data.

The first signal transmission lines include first output lines OUTLINE_{—1}a connected between the timing controller 402 and the s-th data drive IC and second output lines OUTLINE_2a connected between the first output lines OUTLINE_1a and the first to (s−1)-th data drive ICs.

The second signal transmission lines include first output lines OUTLINE_1b connected between the timing controller 403 and the (s+1)-th data drive IC and second output lines OUTLINE_2b connected and between the first output lines OUTLINE_1b and the (s+2)-th to (s+t)-th data drive ICs.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but are illustrative in all aspects.

What is claimed is:

1. A liquid crystal display comprising:
a circuit board;
a timing controller mounted on the circuit board, storing first to (n+m)-th pixel data that is sequentially input such that the pixel data is divided into a first image data set including the first to n-th pixel data and a second image data set including the (n+1)-th to (n+m)-th pixel data, and simultaneously outputting the pixel data from each of the stored first and second image data sets, the data size of the first image data set being smaller than the data size of the second image data set (m>n);
a data driver electrically connected to the circuit board, supplying data voltages corresponding to the pixel data to a plurality of data lines, and comprising a first data drive integrated circuit (IC) group having first to s-th data drive ICs for applying the data voltages corresponding to the first to n-th pixel data and a second data drive IC group having (s+1)-th to (s+t)-th data drive ICs for applying the data voltages corresponding to the (n+1)-th to (n+m)-th pixel data, the number of data drive ICs of the first data drive IC group being smaller than the number of data drive ICs of the second data drive IC (t>s); and
a liquid crystal panel displaying an image according to the data voltages applied through the plurality of data lines.

2. The liquid crystal display of claim 1, wherein the timing controller comprises:
a first memory unit storing the first image data set; and
a second memory unit storing the second image data set.

3. The liquid crystal display of claim 2, wherein the first memory unit and the second memory unit have the same memory size.

4. The liquid crystal display of claim 1, wherein the timing controller comprises a first memory unit and a second memory unit, and allocates a sufficient memory size to store the second image data set to the first memory unit and the second memory unit, and stores the first image data set and the second image data set in the first memory unit and the second memory unit, respectively.

5. The liquid crystal display of claim 1, wherein the timing controller comprises:
a line buffer memory;
a comparing unit receiving first data information indicating the data size of the first image data set and second data information indicating the data size of the second image data set and comparing the data size of the first image data set with the data size of the second image data set; and
a memory allocating unit dividing the line buffer memory into a first memory unit and a second memory unit each having a sufficient memory size to store the second image data set according to the result of the comparison.

6. The liquid crystal display of claim 5, wherein the timing controller further comprises a setup memory supplying the first data information and the second information data to the comparing unit.

7. The liquid crystal display of claim 6, wherein:
the first data information is the number of data lines electrically connected to the first data drive IC group among the plurality of data lines, and
the second data information is the number of data lines electrically connected to the second data drive IC group among the plurality of data lines.

8. The liquid crystal display of claim 1, wherein the timing controller is mounted between portions of the circuit board connected to the s-th data drive IC and the (s+1)-th data drive IC.

9. The liquid crystal display of claim 1, wherein the circuit board comprises:
first signal transmission lines connected between the timing controller and the first data drive IC group and transmitting the first to n-th pixel data; and
second signal transmission lines connected between the timing controller and the second data drive IC group and transmitting the (n+1)-th to (n+m)-th pixel data; and
wherein each of the first and second signal transmission lines comprises:
first output lines provided on a first layer of the circuit board and sequentially transmitting the first to n-th pixel data and the (n+1)-th to (n+m)-th pixel data output from the timing controller at the same time; and
second output lines provided on a second layer of the circuit board and transmitting the first to n-th pixel data and the (n+1)-th to (n+m)-th pixel data transmitted thorough the first output lines to the first to s-th data drive ICs and the (s+1)-th to (s+t)-th data drive ICs through paths, respectively.

10. The liquid crystal display of claim 9, wherein:
the first output lines have a plurality of bent portions; and
the inside angle of each of the bent portions is equal to or larger than 90 degrees.

11. The liquid crystal display of claim 1, wherein the circuit board comprises:
first signal transmission lines connected between the timing controller and the first data drive IC group and transmitting the first to n-th pixel data; and
second signal transmission lines connected between the timing controller and the second data drive IC group and transmitting the (n+1)-th to (n+m)-th pixel data; and
wherein each of the first and second signal transmission lines comprises:
first output lines connected between the timing controller and the s-th data drive IC and between the timing controller and the (s+1)-th data drive IC, respectively; and
second output lines connected between the first output lines and the first to (s−1)-th data drive ICs and between the first output lines and the (s+2)-th to (s+t)-th data drive ICs, respectively.

12. A liquid crystal display comprising:
a timing controller storing first to (n+m)-th pixel data that are sequentially input such that the pixel data is divided into a first image data set including the first to n-th pixel data and a second image data set including the (n+1)-th to (n+m)-th pixel data, and simultaneously outputting the pixel data from each of the stored first and second image data sets;
a data driver comprising a first data drive IC group, wherein the first data drive IC group is supplied with the first to n-th pixel data and applies data voltages corresponding to the first to n-th pixel data to a portion of a plurality of data lines and a second data drive IC group, wherein the second data drive IC group is supplied with the (n+1)-th to (n+m)-th pixel data and applies data voltages corresponding to the (n+1)-th to (n+m)-th pixel data to another portion of the plurality of data lines, the first data drive IC group comprising first to s-th data drive ICs and the second data drive IC group comprising (s+1)-th to (s+t)-th data drive ICs; and
a circuit board having the timing controller mounted thereon and comprising first signal transmission lines, wherein the first signal transmission lines are connected between the timing controller and the first data drive IC group and transmit the first to n-th pixel data and second signal transmission lines, wherein the second signal transmission lines are connected between the timing controller and the second data drive IC group and transmit the (n+1)-th to (n+m)-th pixel data; and
wherein each of the first and second signal transmission lines comprises:
first output lines provided on a first layer of the circuit board and sequentially transmitting the first to n-th pixel data and the (n+1)-th to (n+m)-th pixel data output from the timing controller at the same time; and
second output lines provided on a second layer of the circuit board and transmitting the first to n-th pixel data and the (n+1)-th to (n+m)-th pixel data transmitted through the first output lines to the first to s-th data drive ICs and the (s+1)-th to (s+t)-th data drive ICs through paths, respectively;
wherein the first output lines have a plurality of bent portions, and the inside angle of each of the bent portions is equal to or larger than 90 degrees.

13. The liquid crystal display of claim 12, wherein:
the data size of the first image data set is smaller than the data size of the second image data set (m>n); and
the number of data drive ICs of the first data drive IC group is smaller than the number of data drive ICs of the second data drive IC (t>s).

14. The liquid crystal display of claim 13, wherein the timing controller is mounted between portions of the circuit board connected to the s-th data drive IC and the (s+1)-th data drive IC.

15. The liquid crystal display of claim 12, wherein the timing controller comprises:
a line buffer memory;
a comparing unit comparing the data size of the first image data set with the data size of the second image data set; and
a memory allocating unit dividing the line buffer memory into a first memory unit and a second memory unit each having a sufficient memory size to store the second image data set according to the result of the comparison.

16. The liquid crystal display of claim 15, wherein the timing controller further comprises a setup memory supplying first data information indicating the data size of the first image data set and second information data indicating the data size of the second image data set to the comparing unit.

17. A timing controller comprising:
a line buffer memory;
a comparing unit comparing first data information with second data information; and
a memory allocating unit dividing the line buffer memory into a first memory unit and a second memory unit each having the same memory size according to the result of the comparison.

18. The timing controller of claim 17, wherein:
first to (n+m)-th pixel data are sequentially input and divided into a first image data set including the first to n-th pixel data and a second image data set including the (n+1)-th to (n+m)-th pixel data;
the first data information indicates the data size of the first information data set, and the second data information indicates the data size of the second information data set; and
the memory allocating unit divides the line buffer memory into the first memory unit and the second memory unit each having a memory size corresponding to one of the first data information and the second data information having a larger data size.

19. The timing controller of claim 18, wherein:
the line buffer memory stores the first image data set and the second image data set in the first memory unit and the second memory unit, respectively; and
the line buffer memory simultaneously outputs the pixel data from each of the first and second image data sets.

20. A method for displaying an image on a liquid crystal display according to data voltages applied through a plurality of data lines comprising the steps of:
mounting a timing controller on a circuit board;
storing first to (n+m)-th pixel data that is sequentially input such that the pixel data is divided into a first image data set including the first to n-th pixel data and a second image data set including the (n+1)-th to (n+m)-th pixel data;
simultaneously outputting the pixel data from each of the stored first and second image data sets, wherein the data size of the first image data set is smaller than the data size of the second image data set (m>n);
electrically connecting a data driver to the circuit board;
supplying data voltages corresponding to the pixel data to the plurality of data lines;
applying the data voltages corresponding to the first to n-th pixel data via a first data drive IC group having first to s-th data drive ICs; and
applying the data voltages corresponding to the (n+1)-th to (n+m)-th pixel data via a second data drive IC group having (s+1)-th to (s+t)-th data drive ICs, wherein the number of data drive ICs of the first data drive IC group is smaller than the number of data drive ICs of the second data drive IC (t>s).

21. The method of claim 20 further comprising the steps of:
storing the first image data set to a first memory unit within the timing controller; and
storing the second image data set to a second memory unit within the timing controller.

22. The method according to claim 20 further comprising the steps of:
allocating a sufficient memory size to store the second image data set to a first memory unit and a second memory unit, where said first memory unit and second memory unit exist within the timing controller;
storing the first image data set in the first memory unit; and
storing the second image data set in the second memory unit.

23. The method of claim 20 further comprising the steps of:
receiving first data information indicating the data size of the first image data set;
receiving second data information indicating the data size of the second image data set;
comparing the data size of the first image data set with the data size of the second image data set; and
dividing a line buffer memory into a first memory unit and a second memory unit each having a sufficient memory size to store the second image data set according to the result of the comparison.

24. The method of claim 20, further comprising the step of:
mounting the timing controller between portions of the circuit board connected to the s-th data drive IC and the (s+1)-th data drive IC.

25. The method of claim 20, further comprising the steps of:
connecting first signal transmission lines between the timing controller and the first data drive IC group;
transmitting the first to n-th pixel data via the first signal transmission lines;
connecting second signal transmission lines between the timing controller and the second data drive IC group; and
transmitting the (n+1)-th to (n+m)-th pixel data via the second signal transmission lines.
